(19) United States
(12) Patent Application Publication
(10) Pub. No.: US 2022/0246995 A1
(43) Pub. Date: Aug. 4, 2022

(54) SAFE AND NON-FLAMMABLE SODIUM METAL BATTERIES BASED ON CHLOROALUMINATE ELECTROLYTES WITH ADDITIVES

(71) Applicant: THE BOARD OF TRUSTEES OF THE LELAND STANFORD JUNIOR UNIVERSITY, Stanford, CA (US)

(72) Inventors: Hongjie DAI, Stanford, CA (US); Hao SUN, Stanford, CA (US); Guanzhou ZHU, Stanford, CA (US); Yuanyao LI, Stanford, CA (US)

(73) Assignee: THE BOARD OF TRUSTEES OF THE LELAND STANFORD JUNIOR UNIVERSITY, Stanford, CA (US)

(21) Appl. No.: 17/623,834

(22) PCT Filed: Jul. 2, 2020
(86) PCT No.: PCT/US2020/040731

§ 371 Date: Dec. 29, 2021

Related U.S. Application Data
(60) Provisional application No. 62/870,197, filed on Jul. 3, 2019.

(51) Int. Cl. H01M 10/36; H01M 10/44; H01M 4/04; H01M 10/052; H01M 10/054; H01M 10/0568; H01M 10/0569; H01M 4/38

(52) U.S. Cl. CPC H01M 10/36; H01M 10/44; H01M 4/0407; H01M 10/052; H01M 2300/0028; H01M 10/0568; H01M 10/0569; H01M 4/382; H01M 10/054

(57) ABSTRACT

Provided herein are rechargeable alkali metal batteries comprising: an anode including an alkali metal; a cathode; and an electrolyte to support reversible plating and stripping of the alkali metal at the anode, wherein the electrolyte includes alkali metal ions, chloroaluminate anions (AlClri), and an additive including imide anions.

### CROSS-REFERENCE TO RELATED APPLICATIONS

This application claims the benefit of U.S. Provisional Patent Application No. 62/870,197, filed Jul. 3, 2019, which is incorporated by reference herein in its entirety.

### BACKGROUND

High-energy rechargeable battery systems have been actively pursued for a wide range of applications from portable electronics to grid energy storage and electric automotive industry. At higher energies battery safety becomes increasingly important, evident from high profile battery fires/explosion accidents in recent years. Rechargeable batteries using flammable organic electrolytes always risk fire/explosion hazards when short circuit or thermal runaway happens, setting a bottleneck in battery design/engineering and specifying innovations of next-generation battery systems with intrinsically higher safety. For organic electrolytes various strategies have been investigated to mitigate the safety concerns, including the use of voltage or temperature-sensitive separators and overcharge protection additives. Developing electrolyte systems that are intrinsically non-flammable has also been actively pursued. In particular, room temperature ionic liquids (ILs) have been widely explored as promising candidates due to their non-flammable nature. Among them, ILs comprised of AlCl₃ and 1-ethyl-3-methylimidazolium chloride ([EMIm]Cl) are a chloroaluminate based electrolyte system with many desired properties including non-flammability, non-volatility, low viscosity, high conductivity, and high thermal stability and chemical inertness. In this electrolyte, AlCl₃ complexes with the Cl ion from [EMIm]Cl to produce AlCl₄⁻ and EMIm⁺, and any excess AlCl₃ converts a portion of AlCl₄⁻ into Al₂Cl₇⁻, resulting in the coexistence of AlCl₄⁻ and Al₂Cl₇⁻:

AlCl₃+[EMIm]Cl [symbol] AlCl₄⁻+[EMIm]⁺ (I)

AlCl₄⁻+AlCl₃ [symbol] Al₂Cl₇⁻ (2)

The AlCl₃/[EMIm]Cl-based ILs can be used as electrolytes for rechargeable metal batteries. An example is a rechargeable aluminum-graphite battery with fast and highly reversible AlCl₄⁻ intercalation/de-intercalation into graphite positive electrode, and Al₂Cl₇⁻ plating and stripping on Al negative electrode. Nevertheless, it is desirable to develop higher voltage and higher energy density battery systems utilizing chloroaluminate IL electrolytes. A promising strategy is replacing Al by more reactive metal negative electrodes with lower standard electrode potentials such as sodium and lithium, which could raise the battery voltage and allow the use of positive electrode materials with higher energy densities. A buffered AlCl₃/[EMIm]Cl IL system can be implemented by adding NaCl, eliminating Al₂Cl₇⁻ and introducing Na ions into the electrolyte via

Al₂Cl₇⁻+NaCl [symbol] 2AlCl₄⁻+Na⁺ (3)

Thus far however, reversible and stable deposition and stripping/oxidation of Na metal in buffered AlCl₃/[EMIm]Cl ILs towards rechargeable Na batteries have been hindered, with or without the use of a variety of electrolyte additives such as HCl, [EMIm]HCl₂, triethanolamine hydrochloride and thionyl chloride. These additives can stabilize Na redox to constrained degrees, affording Coulombic efficiencies (CEs) of 65-94% for Na plating/stripping. For instance, the CE record of reversible Na redox was 94% achieved with about 6 Torr HCl added to NaCl-buffered AlCl₃/[EMIm]Cl=about 1.7 IL at 6.4 mA cm⁻², but it rapidly decayed at a lower current density. None of the chloroaluminate ILs could afford multicycle Na plating/stripping with sufficiently high CE to pair with sodium positive electrode for Na battery cells.

### SUMMARY

Some embodiments include a rechargeable alkali metal battery comprising: an anode including an alkali metal; a cathode; and an electrolyte to support reversible plating and stripping of the alkali metal at the anode, wherein the electrolyte includes alkali metal ions, chloroaluminate anions (AlCl₄⁻), and an additive including imide anions. In some embodiments, the imide anions are selected from:

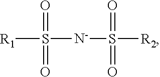

where R₁ and R₂ are the same or different, and are independently selected from (a) fluorine (F) and (b) linear or branched alkyl groups substituted with 1 or more fluorine atoms. In some embodiments, the imide anions include bis(fluorosulfonyl)imide anions (FSI⁻), bis(trifluoromethanesulfonyl)imide anions (TFSI⁻), or both. In some embodiments, a molar concentration of the imide anions in the electrolyte is in a range of about 1 M or less, about 0.9 M or less, about 0.8 M or less, about 0.7 M or less, about 0.6 M or less, about 0.5 M or less, about 0.4 M or less, about 0.3 M or less, or about 0.2 M. In some embodiments, the electrolyte is an ionic liquid. In some embodiments, the ionic liquid further includes 1-ethyl-3-methylimidazolium (EMI) cations, imidazolium cations, pyrrolidinium cations, piperidinium cations, phosphonium cations, alkylammonium cations, or any combination thereof. In some embodiments, the electrolyte is an ionic liquid formed by adding alkali metal chloride to buffer an acidic AlCl₃/organic chloride ionic liquid to neutral, followed by adding an additive containing FSI⁻, TFSI⁻ or mixed FSI⁻/TFSI⁻ and a water removal agent. In some embodiments, the electrolyte is an ionic liquid formed by adding x part (0<x<1) of NaCl, 0.01-0.02 part of ethylaluminum chloride, 0.02 to 0.06 part of EMIFSI to 1 part of an acidic AlCl₃:1-ethyl-3-methylimidazolium chloride (EMIC) ionic liquid (AlCl₃:EMIC=1 to 1+x, 0<x<1). In some embodiments, the ionic liquid has an ionic conductivity at 25° C. of about 1 mS cm⁻¹ or greater, about 2 mS cm⁻¹ or greater, about 4 mS cm⁻¹ or greater, about 6 mS cm⁻¹ or greater, about 8 mS cm⁻¹ or greater, or about 9 mS cm⁻¹ or greater. In some embodiments, the electrolyte includes thionyl chloride dissolved with 0-5 M NaCl and 1-5 M AlCl₃, and 0-10 wt. % of an additive of NaFSI, NaTFSI, or mixed NaFSI and NaTFSI. In some embodiments, the electrolyte includes sulfuryl chloride dissolved with 0-5 M NaCl and 1-5 M AlCl₃, and 0-10 wt. % of an additive of NaFSI, NaTFSI, or mixed NaFSI and NaTFSI. In some embodiments, the electrolyte includes a solvate electrolyte formed by sulfur dioxide, NaCl and AlCl₃, and an additive of NaFSI, NaTFSI or mixed NaFSI and NaTFSI. In some embodiments, the electrolyte includes thionyl chloride dissolved with 0-5 M LiCl and 1-5 M AlCl₃, and 0-10 wt. % of an additive of LiFSI, LiTFSI, or mixed LiFSI and LiTFSI. In some embodiments, the electrolyte includes sulfuryl chloride dissolved with 0-5 M LiCl and 1-5 M AlCl₃, and 0-10 wt. % of an additive of LiFSI, LiTFSI, or mixed LiFSI and LiTFSI. In some embodiments, the electrolyte includes a solvate electrolyte formed by sulfur dioxide, LiCl and AlCl₃, and an additive of LiFSI, LiTFSI or mixed LiFSI and LiTFSI. In some embodiments, the cathode includes an inorganic material or an organic material. In some embodiments, the alkali metal is sodium. In some embodiments, the alkali metal is potassium. In some embodiments, the alkali metal is lithium.

### BRIEF DESCRIPTION OF THE DRAWINGS

FIG. 1 shows an embodiment of properties of a buffered Na—Cl-IL electrolyte. FIG. 1a is a schematic illustration of a battery configuration and electrolyte composition of an embodiment of the IL electrolyte. FIG. 1b is Raman spectra of an embodiment of ILs based on AlCl₃/[EMIm]Cl=1.5 with different additives. FIG. 1c is ionic conductivities of an embodiment of buffered Na—Cl-IL and other IL-based electrolytes for an embodiment of Na batteries at about 25° C. FIG. 1d shows thermal stability tests using an embodiment of buffered Na—Cl-IL. FIG. 1e shows flammability tests using an embodiment of buffered Na—Cl-IL and 1.0 M NaClO₄ in EC:DEC (1:1 by vol) with about 5 wt. % FEC electrolytes. Figure if shows flammability tests using an embodiment of buffered Na—Cl-IL at about 1.0 M NaClO₄ in EC:DEC (1:1 by vol) with about 5 wt. % FEC electrolytes. Scale bars in FIGS. 1e, f, are 1 cm.

FIG. 2 shows an embodiment of electrochemical properties of the buffered Na—Cl-IL electrolyte. FIG. 2a shows a linear sweep voltammetry profile of buffered Na—Cl-IL electrolyte. Working electrode, carbon fiber paper. Counter and reference electrode, Na foil. Scan rate, about 2 mV s⁻¹. FIG. 2b and FIG. 2c show CV curves of Na/Pt cells using buffered+EtAlCl₂ additive and buffered Na—Cl-IL electrolyte at a scan rate of about 2 mV respectively. FIG. 2d shows Na plating/stripping profiles of Na/Pt cells using buffered Na—Cl-IL electrolyte at a current density of about 0.5 mA cm⁻². FIG. 2e shows Na plating/stripping Coulombic efficiency of a Na/Pt cell using Buffered Na—Cl-IL electrolyte at about 0.5 mA cm⁻². The plating capacity in FIG. 2d and FIG. 2e is about 0.25 mAh cm⁻².

FIG. 3 shows an embodiment of Na/NVP/@GO cell performances in buffered Na—Cl-IL electrolyte. FIG. 3a shows CV curves of a Na/NVP@rGO cell using buffered Na—Cl-IL electrolyte at a scan rate of about 2 mV s⁻¹. FIG. 3b shows initial galvanostatic charge-discharge curves of a Na/NVP@rGO cell using buffered Na—Cl-IL electrolytes with and without [EMIm]FSI additive at about 25 mA FIG. 3c shows galvanostatic charge-discharge curves of a Na/NVP@rGO cell using buffered Na—Cl-IL electrolyte at varied current densities from about 25 to about 400 mA FIG. 3d and FIG. 3e show rate and cyclic stability of a Na/NVP@rGO cell using buffered Na—Cl-IL electrolyte. The boxed region of FIG. 3e corresponds to the rate performance of FIG. 3d at varied current densities from about 20 to about 500 mA After that, a current density of about 150 mA g⁻¹ was used for cycling.

FIG. 4 shows an embodiment of Na/NVPF@GO cell performances in buffered Na—Cl-IL electrolyte. FIG. 4a shows galvanostatic charge-discharge curves of a Na/NVPF@rGO cell at varied current density from about 50 to about 500 mA FIG. 4b shows capacity and Coulombic efficiency retention of a Na/NVPF@rGO cell when cycled at different current densities from about 50 to about 500 mA FIG. 4c and FIG. 4d show Ragone and Radar plots of this disclosure compared with other reported room-temperature Na batteries based on IL electrolytes, respectively. The specific capacity, energy and power density in this disclosure and other reports were all calculated based on the mass of active materials on positive electrode. The cycle life in FIG. 4d is determined by the cycle number when the capacity dropped below about 90% of the original capacity. Ref. 29-1, 2 and 3 represent three different IL electrolytes based on 1 M NaBF₄, NaClO₄ and NaPF₆ salts, respectively. FIG. 4e shows cyclic stability of a Na/NVPF@rGO cell using buffered Na—Cl-IL electrolyte at about 300 mA g⁻¹.

FIG. 5 shows an embodiment of morphology and solid-electrolyte interphase (SEI) probing of the plated Na in buffered Na—Cl-IL electrolyte. FIG. 5a-d show high-resolution XPS spectra for Na Auger and 01 s FIG. 5(a), F is FIG. 5(b), Al 2p FIG. 5(c) and Cl 2p FIG. 5(d) of the Na negative electrode from a NaNVP@rGO cell with NVP@rGO mass loading of about 5.0 mg cm⁻¹ at different depths, respectively. The cell was cycled at about 100 mA g⁻¹ (about 0.5 mA cm⁻²) for 20 cycles and stopped at fully charged state prior to characterization. FIG. 5e shows Cryo-TEM image of Na-plated Cu grid at a current density of about 0.1 mA cm⁻². Scale bar, 500 nm. FIG. 5f and FIG. 5g show high-resolution Cryo-TEM images and diffraction patterns (inset) of SEI concerning Al₂O₃ and NaCl. Scale bars in FIG. 5f, FIG. 5g are 5 nm. h, High-angle annular dark-field (HAADF) and the corresponding element mapping images for SEI composition probing using STEM. Scale bar, 100 nm.

FIG. 6 shows an embodiment of sodium-microporous carbon nanosphere battery using about 3 M AlCl₃ in SOCl₂+about 2 wt. % NaFSI+about 2 wt. % NaTFSI as the electrolyte FIG. 6a shows first discharge behavior of the battery. FIG. 6b shows Coulombic Efficiency comparison between the batteries with and without the additive of about 2 wt. % NaFSI+about 2 wt. % NaTFSI. FIG. 6c shows a typical charge-discharge behavior of the battery.

FIG. 7 shows an embodiment of Na plating/stripping profiles of a Na/Pt cell using buffered Na—Cl-IL electrolyte without [EMIm]FSI additive at a current density of about 0.5 mA cm⁻².

FIG. 8 shows an embodiment of morphology of Na plating at different current densities. FIG. 8a and FIG. 8b show SEM images of Na-plated Cu foils in Na/Cu cells at a current density of about 0.5 and about 1.5 mA cm⁻², respectively. Specific capacity, about 0.5 mAh cm⁻². The cells were cycled for 5 cycles and stopped at discharge state (Na plating on Cu) prior to characterization. Scale bars in FIG. 8a and FIG. 8b, 10 μm.

FIG. 9 shows an embodiment of a cross-section morphology of Na plating. FIG. 9a and FIG. 9b show SEM images of a Na particle before FIG. 9(a) and after FIG. 9(b) cutting via focused ion beam. Scale bars in FIG. 9a and FIG. 9b, 5 μm.

FIG. 10 shows an embodiment of a SEM image and the corresponded element mapping images of the cross section of a Na particle via FIB cutting. The Na particle was plated on a Cu foil at a current density of about 0.5 mA cm⁻² in a Na/Cu cell. The cell was first cycled for 10 cycles and stopped at discharge state (Na plating on Cu) prior to characterization. Scale bar, 5 μm.

FIG. 11 shows an XRD pattern for an embodiment of NVP@rGO.

FIG. 12a shows morphology of an embodiment of NVP@rGO in a SEM image of NVP@rGO at low magnification. FIG. 12b shows morphology of an embodiment of NVP@rGO in a SEM image of NVP@rGO at high magnification. Scale bars in a and b are 500 nm and 200 nm, respectively.

FIG. 13a shows a TEM image of an embodiment of NVP@rGO. FIG. 13b shows a high-resolution TEM image of an embodiment of NVP@rGO. Scale bars in a and b are 200 nm and 5 nm, respectively.

FIG. 14 shows a TGA of an embodiment of NVP@rGO within a temperature range of about 25-800° C. with a heating rate of about 5° C. min⁻¹ in air

FIG. 15 shows an embodiment of the variation of specific discharge capacity of an embodiment of NVP@rGO on IL electrolytes with different molar ratios of AlCl₃ and EMIC. Current density, about 25 mA g⁻¹. The specific capacity of this Na-NVP@rGO battery showed a dependence with the molar ratio of AlCl₃/[EMIm]Cl. Increasing the molar ratio from about 1.2 to about 1.5 enhanced the specific capacity, likely due to the increased Na ion concentration. However, when the molar ratio further reached about 1.6, the specific capacity decreased slightly likely due to increased viscosity.

FIG. 16a shows cyclic stability of an embodiment of a Na/NVP@rGO cell using organic electrolyte of about 1 M NaClO₄ in ethylene carbonate/diethyl carbonate (EC/DEC, 1:1 by vol) with about 5% FEC at a current density of about 150 mA g⁻¹. FIG. 16b shows galvanostatic charge-discharge curves of an embodiment of Na/NVP@rGO cells with different NVP@rGO loadings of about 3.0, about 5.0 and about 8.0 mg cm⁻² at a current density of about 25 mA g⁻¹. FIG. 16c shows XRD patterns of NVPF and of an embodiment of NVPF@rGO.

FIG. 17 shows an SEM image of an embodiment of NVPF@rGO. Scale bar, 500 nm.

FIG. 18 shows TGA of an embodiment of NVPF@rGO within a temperature range of about 25-800° C. with a heating rate of about 5° C. min⁻¹ in air. The temperature range used for determining rGO percentage is about 180-460° C.

FIG. 19a shows a CV curve of an embodiment of a Na/NVPF@rGO cell using Na⁺—C-IL electrolyte at a scan rate of about 0.1 mV s⁻¹. FIG. 19b shows a variety of specific capacity and energy density on different mass loadings from about 3 to about 8 mg cm⁻². The inset showed corresponding galvanostatic charge-discharge curves with different loadings at about 50 mA g⁻¹.

FIG. 20a shows cyclic stability of an embodiment of a Na/NVPF@rGO cell with a NVPF@rGO mass loading of about 5.3 mg cm⁻² using buffered+EtAlCl₂/[EMIm]FSI additive IL electrolyte. Current density, about 150 mA g⁻¹. FIG. 20b shows cyclic stability of an embodiment of a Na/NVPF@rGO cell using buffered Na⁺—C-IL electrolyte without EtAlCl₂ additive at about 150 mA g⁻¹ for 300 cycles. The mass loading of NVPF@rGO was about 3.0 mg cm⁻².

FIG. 21a shows surface XPS spectrum of an embodiment of a Na anode from a Na/NVP@rGO cell with the NVP@rGO mass loading of about 5.0 mg cleat fully charged state. Prior to XPS measurement, the cell was cycled for 20 cycles at about 100 mA/g for sufficient formation of SEI. FIG. 21b shows high-resolution XPS spectra for N is an embodiment of the Na anode from a Na/NVP@rGO cell with the NVP@rGO mass loading of about 5.0 mg cm⁻² at different depths. Prior to XPS measurement, the cell was cycled for 20 cycles at about 1 C for sufficient formation of SEI.

FIG. 22 shows capacity and Colombic efficiency retention of a Na/NVP@rGO cell using NaFSI/N-propyl-N-methylpyrrolidinium bis(fluorosufonyl)imide (molar ratio of about 2:8) IL electrolyte. Current density, about 150 mA g⁻¹.

FIG. 23 shows Galvanostatic charge-discharge curves of a Na/NVP@rGO cell using NaFSI/N-propyl-N-methylpyrrolidinium bis(fluorosufonyl)imide (molar ratio of about 2:8) IL electrolyte at varied current densities from about 25 to about 400 mA g⁻¹.

### DETAILED DESCRIPTION

Some embodiments of this disclosure are directed to chloroaluminate ion based electrolytes spiked with bis(fluorosulfonyl)imide or bis(trifluoromethanesulfonyl)imide anions. Sodium metal is stabilized in chloroaluminate ion-containing electrolytes with the aid of either, or both, bis(fluorosulfonyl)imide anion or bis(trifluoromethanesulfonyl)imide anion, and thus realize high-performance sodium metal batteries. This leads to chloroaluminate-based ionic liquid electrolyte for rechargeable sodium metal batteries. The obtained batteries can reach voltages up to about 4 V (or more), high Coulombic efficiency up to about 99.9% (or more), and high energy and power density of about 420 Wh kg (or more) and about 1766 W kg (or more), respectively. The batteries can retain over about 90% (or more) of an original capacity after 700 cycles, indicating an improved approach to sodium metal batteries with high energy/high power density, long cycle life and high safety. In another example, sodium-carbon batteries based on AlCl₃/NaCl/SOCl₂ are also realized with the addition of about 2 wt. % sodium bis(fluorosulfonyl)imide and about 2 wt. % sodium bis(trifluoromethanesulfonyl)imide.

Stabilizing sodium anode in chloroaluminate ion-containing electrolyte is highly challenging due to the corrosion effect of chloroaluminate ion, which results in poor cyclic stability of sodium metal batteries. Here, in some embodiments, bis(fluorosulfonyl)imide or bis(trifluoromethanesulfonyl)imide anions are beneficial for stabilizing sodium metal in chloroaluminate ion-containing electrolytes. With a small amount (e.g., about 2-4% by weight) added into an electrolyte, the additives can largely enhance battery performances with up to 700 stable charge-discharge cycles achieved.

Certain embodiments of this disclosure are directed to an ionic liquid electrolyte based on NaCl-buffered AlCl₃/[EMIm]Cl for safe and high energy Na batteries. In some embodiments, two electrolyte additives at the about 1 to about 4% by mass level, e.g., ethylaluminum dichloride (EtAlCl₂) and 1-ethyl-3-methylimidazolium bis(fluorosulfonyl)imide ([EMIm]FSI) are used to stabilizing SEI on sodium negative electrode for reversible Na plating/stripping. In a Na/Pt cell containing this IL electrolyte, a CE of about 95% is reached at about 0.5 mA cm⁻² over about 100 reversible Na plating/stripping cycles. With the optimized IL electrolyte, Na negative electrode is paired with sodium vanadium phosphate (NVP) and sodium vanadium phosphate fluoride (NVPF) based positive electrodes to afford high discharge voltage up to about 4 V, high CEs up to about 99.9%, and maximal energy and power density of about 420 Wh kg⁻¹ and about 1766 W kg⁻¹ respectively based on active material mass of positive electrode. In addition, more than about 90% of the original capacity is retained after over 700 cycles. Solid-electrolyte interphase (SEI) analysis reveals SEI compositions including NaCl, Al₂O₃ and NaF derived from the reactions between Na and the anions in the IL electrolyte. The results shed light on advances towards a practical commercial sodium metal batteries with high safety and high energy/power densities.

Rechargeable sodium metal batteries with high energy density can be important to a wide range of energy applications in modern society. The pursuit of higher energy density should ideally come with high safety, a goal difficult for electrolytes based on organic solvents. Certain aspects of this disclosure presents a chloroaluminate ionic liquid electrolyte comprised of aluminum chloride/1-ethyl-3-methylimidazolium chloride/sodium chloride ionic liquid spiked with two additives, ethylaluminum dichloride and 1-ethyl-3-methylimidazolium bis(fluorosulfonyl)imide. This leads to the first chloroaluminate based ionic liquid electrolyte for rechargeable sodium metal battery. The obtained batteries reached voltages up to about 4 V, high Coulombic efficiency up to about 99.9%, and high energy and power density of about 420 Wh kg⁻¹ and about 1766 W kg⁻¹, respectively. The batteries retained over about 90% of the original capacity after 700 cycles, indicating an improved approach to sodium metal batteries with high energy/high power density, long cycle life and high safety.

In some embodiments, an alkali metal battery includes: (1) an anode including an alkali metal; (2) a cathode; and (3) an electrolyte to support reversible plating and stripping of the alkali metal at the anode, wherein the electrolyte includes alkali metal ions, chloroaluminate anions (AlCl₄⁻), and an additive including imide anions.

In some embodiments, the imide anions are selected from:

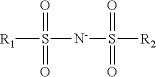

where R₁ and R₂ are the same or different, and are independently selected from (a) fluorine (F) and (b) linear, cyclo or branched alkyl groups, such as containing 1 to 10, 1 to 8, 1 to 6, 1 to 4, or 1 to 2 carbon atoms, and substituted with 1, 2, 3, 4, or more fluorine atoms. In some embodiments, the linear or branched alkyl groups are perfluorinated. In some embodiments, the imide anions include bis(fluorosulfonyl)imide anions (FSI⁻), bis(trifluoromethanesulfonyl)imide anions (TFSI⁻), or both. In some embodiments, a molar concentration of the imide anions in the electrolyte is a non-zero value in a range of about 1 M or less, about 0.9 M or less, about 0.8 M or less, about 0.7 M or less, about 0.6 M or less, about 0.5 M or less, about 0.4 M or less, about 0.3 M or less, or about 0.2 M. In some embodiments, a molar concentration of the imide anions in the electrolyte is greater than about 0.05 M, about 0.1 M, about 0.15 M. In some embodiments, a molar concentration of the imide anions in the electrolyte is within a range of the above values.

In some embodiments, the electrolyte is an ionic liquid. In some embodiments, the electrolyte further includes 1-ethyl-3-methylimidazolium (EMI) cations, imidazolium cations, pyrrolidinium cations, piperidinium cations, phosphonium cations, alkylammonium cations, or any combination thereof. In some embodiments, the electrolyte is an ionic liquid formed by adding alkali metal chloride to buffer an acidic AlCl₃/organic chloride ionic liquid to neutral, followed by adding an additive containing the embodied imide anions, e.g., FSI⁻, TFSI⁻ or mixed FSP/TFSP and a water removal agent. In some embodiments, the electrolyte is an ionic liquid formed by adding x part (0<x<1) of NaCl, 0.01-0.02 part of ethylaluminum chloride, 0.02 to 0.06 part of EMIFSI to 1 part of an acidic AlCl₃:1-ethyl-3-methylimidazolium chloride (EMIC) ionic liquid (AlCl₃:EMIC=1 to 1+x, 0<x<1). In some embodiments, the electrolyte has an ionic conductivity of about 1 mS cm⁻¹ or greater at 25° C., such as about 2 mS cm⁻¹ or greater, about 4 mS cm⁻¹ or greater, about 6 mS cm⁻¹ or greater, about 8 mS cm⁻¹ or greater, or about 9 mS cm⁻¹ or greater.

In some embodiments, the electrolyte includes thionyl chloride dissolved with 0-5 M NaCl and 1-5 M AlCl₃, and 0-10 wt. % of an additive of a salt (e.g., sodium salt) of the embodied imide anions, e.g., NaFSI, NaTFSI, or mixed NaFSI and NaTFSI. In some embodiments, the electrolyte includes sulfuryl chloride dissolved with 0-5 M NaCl and 1-5 M AlCl₃, and 0-10 wt. % of an additive of a salt (e.g., sodium salt) of the embodied imide anions, e.g., NaFSI, NaTFSI, or mixed NaFSI and NaTFSI. In some embodiments, the electrolyte includes a solvate electrolyte formed by sulfur dioxide, NaCl and AlCl₃, and an additive of a salt (e.g., sodium salt) of the embodied imide anions, e.g., NaFSI, NaTFSI or mixed NaFSI and NaTFSI. In some embodiments, the electrolyte includes thionyl chloride dissolved with 0-5 M LiCl and 1-5 M AlCl₃, and 0-10 wt. % of an additive of a salt (e.g., lithium salt) of the embodied imide anions, e.g., LiFSI, LiTFSI, or mixed LiFSI and LiTFSI. In some embodiments, the electrolyte includes sulfuryl chloride dissolved with 0-5 M LiCl and 1-5 M AlCl₃, and 0-10 wt. % of an additive of a salt (e.g., lithium salt) of the embodied imide anions, e.g., LiFSI, LiTFSI, or mixed LiFSI and LiTFSI. In some embodiments, the electrolyte includes a solvate electrolyte formed by sulfur dioxide, LiCl and AlCl₃, and an additive of a salt (e.g., lithium salt) of the embodied imide anions, e.g., LiFSI, LiTFSI or mixed LiFSI and LiTFSI.

In some embodiments, the cathode includes an inorganic material (e.g., alkali metal cathode materials such as alkali metal vanadium phosphate and alkali metal vanadium phosphate fluoride) or an organic material (e.g., various forms of carbon such as graphite, nano-graphite, graphene, amorphous carbon, acetylene black, mesoporous carbon, porous carbon nanospheres, or any combination thereof). In some embodiments, the alkali metal is sodium. In some embodiments, the alkali metal is potassium. In some embodiments, the alkali metal is lithium.

### EXAMPLES

### Properties of NaCl Buffered AlCl₃/[EMIm]Cl Ionic Liquid

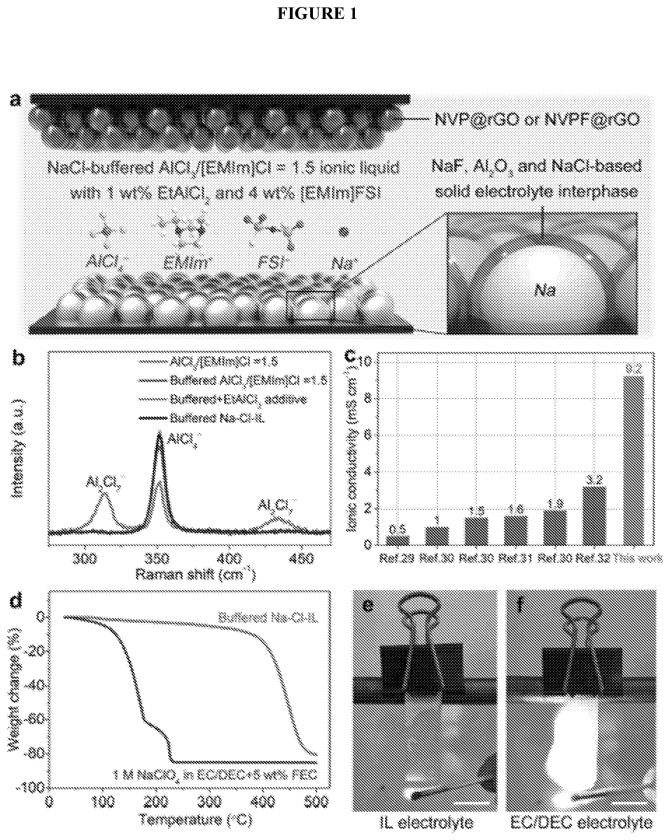

Preparation of IL electrolyte (see Method) started by mixing anhydrous AlCl₃ and [EMIm]Cl at a molar ratio of about 1.5:1 to form an acidic room-temperature IL (AlCl₃/[EMIm]Cl=1.5), followed by buffering to neutral with excess NaCl and then adding about 1 wt. % EtAlCl₂ and about 4 wt. % [EMIm]FSI to afford the final NaCl-buffered chloroaluminate IL electrolyte (referred as ‘buffered Na—Cl-IL electrolyte’) (FIG. 1a). Raman spectroscopy was performed to probe the evolution of AlCl₄⁻ and Al₂Cl₇⁻ species in the IL at different stages (FIG. 1b). Both AlCl₄⁻ and Al₂Cl₇⁻ peaks were observed in the starting acidic IL with AlCl₃/[EMIm]Cl=1.5. After NaCl buffering of the electrolyte to neutral, the Al₂Cl₇⁻ peaks at about 309 and about 430 cm⁻¹ disappeared while the AlCl₄ peak at about 350 cm⁻¹ strengthened, indicating the conversion of Al₂Cl₇⁻ to AlCl₄⁻ by NaCl on the basis of equation (3). Subsequent addition of about 1 wt. % EtAlCl₂ resulted in a noticeable further enhancement of the AlCl₄⁻ peak. This was attributed to reactions of EtAlCl₂ with trace amounts of protons and undissolved NaCl in the buffered AlCl₃/[EMIm]Cl=1.5 IL with the generation of AlCl₄⁻, C₂H₆ and Na⁺ via:

EtAlCl₂+H⁺+2NaCl→C₂H₆(g)+AlCl₄⁻+2Na⁺ (4)

No noticeable change in the Raman spectrum of chloroaluminate species was observed after the addition of about 4 wt. % [EMIm]FSI (FIG. 1b). The final buffered electrolyte (named buffered Na—Cl-IL herein) was comprised of Na⁺, AlCl₄⁻, EMIm+ and FSP with Na⁺ and FSP molar concentration of about 1.76 M and about 0.2 M, respectively.

An important property of the buffered Na—Cl-IL was its high ionic conductivity of about 9.2 mS cm⁻¹ at about 25° C., which was about 2-20 times higher than other IL electrolytes based on bulky cations (e.g., N-butyl-N-methylpyrrolidinium and N-propyl-N-methylpyrrolidinium) for Na batteries (FIG. 1c). The ionic conductivity was comparable to organic electrolytes, for example about 6.5 mS cm⁻¹ of 1 M NaClO₄ in propylene carbonate (PC), and about 6.35 mS cm⁻¹ of 1 M NaClO₄ in ethylene carbonate/diethyl carbonate (EC/DEC, 1:1 by weight). The thermal stability of the buffered Na—Cl-IL electrolyte was compared with an organic electrolyte of about 1 M NaClO₄ in EC/DEC (1:1 by vol) with about 5 wt. % FEC additive by thermogravimetric analysis (TGA) (FIG. 1d). The organic electrolyte showed a rapid weight loss above about 132° C., and lost about 85% of the original weight at about 230° C. due to decomposition of the carbonate solvents in this temperature range. In comparison, the buffered Na—Cl-IL showed a much better thermal stability without severe weight loss until about 400° C. The non-flammable nature of the buffered Na—Cl-IL electrolyte was confirmed when it was soaked into a porous separator and contacted with flame (FIG. 1e) without causing fire. In contrast, the organic carbonate electrolyte readily caught fire and burned immediately (FIG. 1f).

### Electrochemistry of Na—Cl-IL Electrolyte

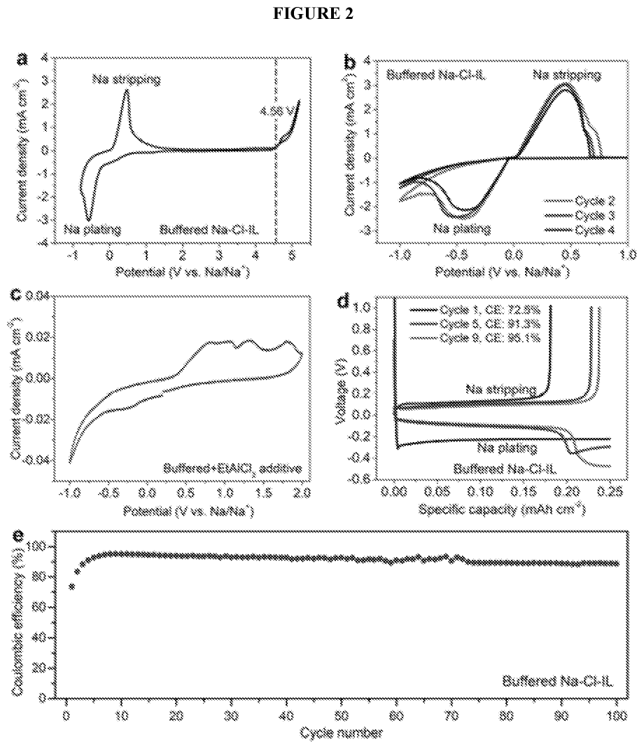

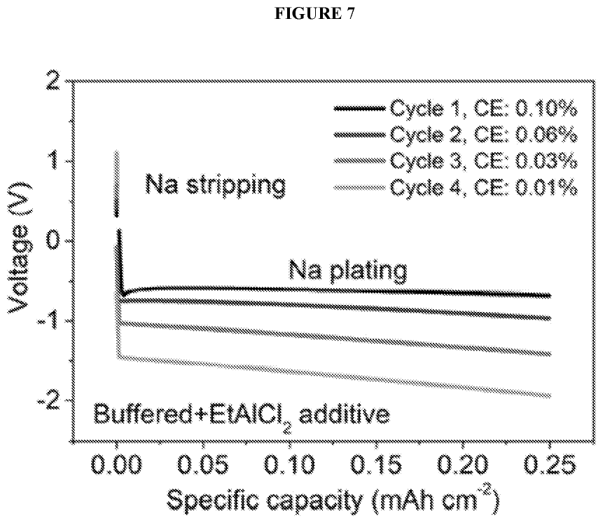

In a Na vs. carbon-fibre-paper cell containing the buffered Na—Cl-IL electrolyte, linear sweep voltammetry scan was performed (FIG. 2a) and revealed a pair of sodium redox peaks on the cathodic side and no noticeable electrolyte decomposition was observed until about 4.56 V on the anodic side, indicating high electrochemical stability of the electrolyte for high-voltage sodium battery systems. Sodium reduction/oxidation peaks were clearly observed in cyclic voltammetry (CV) with a Pt working electrode, a Na reference and counter electrode in buffered Na—Cl-IL electrolyte, showing reversible Na plating and stripping on Pt (FIG. 2b). In striking contrast, redox peaks were completely missing in buffered electrolyte without [EMIm]FSI additive, indicating its role of stabilizing Na plating/stripping (FIG. 2c). Galvanostatic charge-discharge test investigated Na plating/stripping on Pt in buffered Na—Cl-IL electrolyte at a plating current density of about 0.5 mA cm⁻² for about 30 min. The CE increased from about 72% to about 91% during the first 5 cycles for SEI formation and then reached about 95%, which is a record of Na redox for both buffered chloroaluminate ILs and any other ionic liquids based on different cations (including benzyldimethylethylammonium, butyldimethylpropylammonium, trimethylhexylammonium, dibutyldimethylammonium and N-butyl-N-methylpyrrolidinium) and anions (including FSI and TFSI) (FIG. 2d, TFSI represents bis(trifluoromethanesulfonyl)imide). Reversible Na plating/stripping cycling was performed for 100 cycles (FIG. 2e), which was the first-time multicycle Na redox was performed in buffered AlCl₃/[EMIm]Cl ILs. Without [EMIm]FSI additive in buffered AlCl₃/[EMIm]Cl=about 1.5 electrolyte, plating current was observed but without observable stripping capacity (FIG. 7).

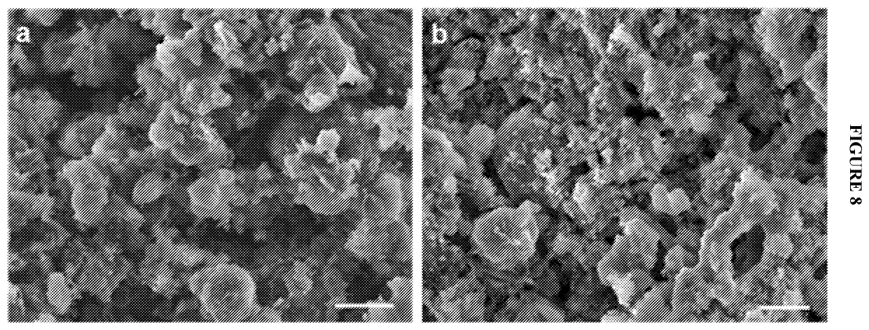

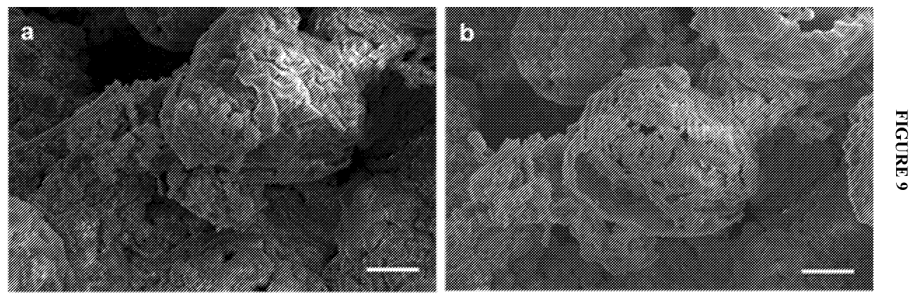

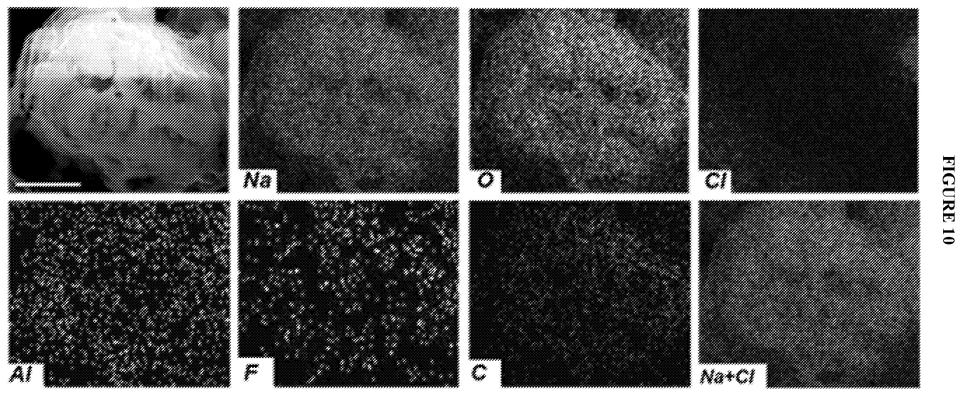

The morphology of the plated Na on Cu after five plating/stripping cycles at a current density of about 0.5 and about 1.5 mA cm⁻² was investigated by scanning electron microscopy (SEM), showing particle sizes ranging from about 5-10 μm without noticeable dendritic morphology (FIG. 8). The inner part of the Na particle was analyzed using focused ion beam (FIB) to expose cross section of the interior (FIG. 9). EDS element mapping of the cross section revealed the existence of Na as the major element, together with O, Al, F and C, and very little Cl was detected inside the particle, indicating the distribution of Cl mainly on the surface of Na rather than inside (FIG. 10). More detailed analysis of SEI on sodium negative electrodes are shown later in the following.

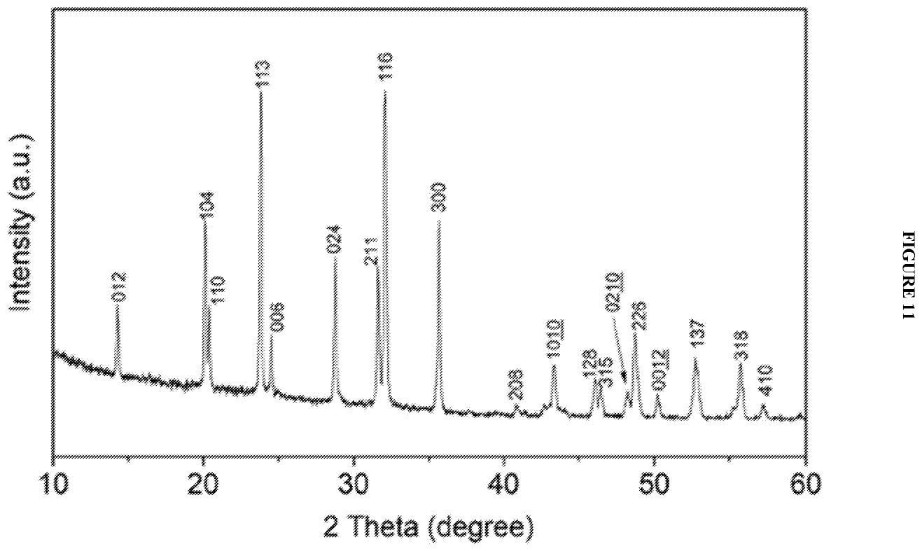

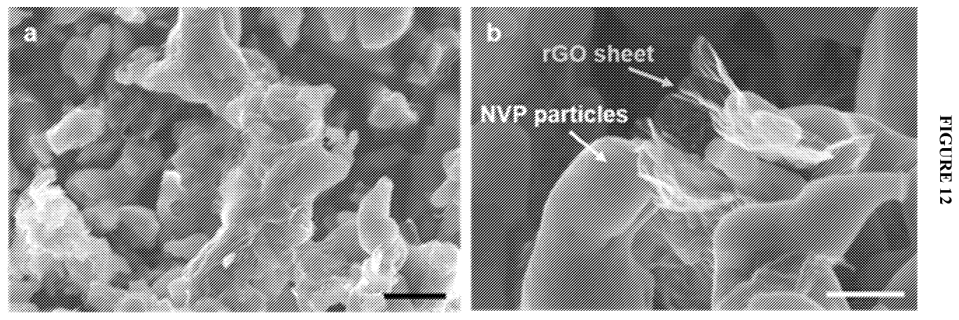

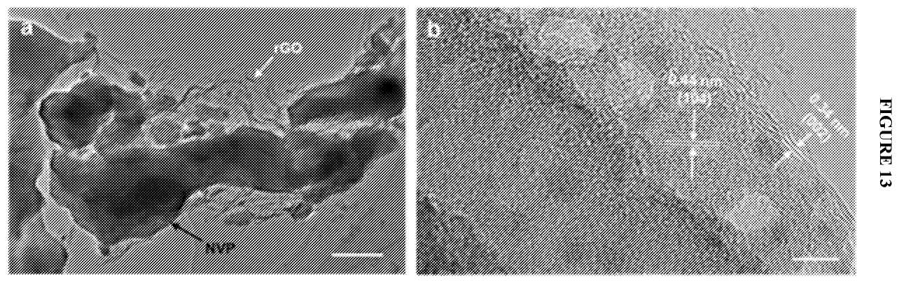

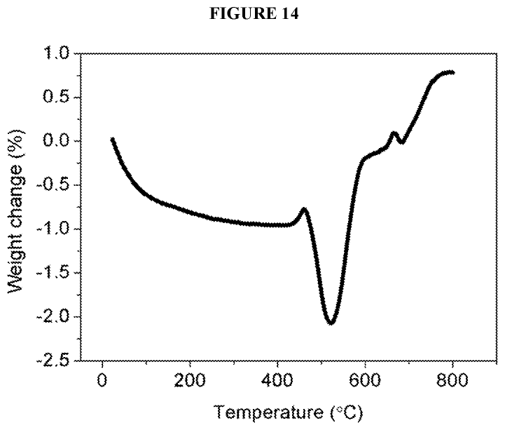

Next, a Na metal battery is prepared by pairing a Na negative electrode with a positive electrode formed by coating Na₃V₂(PO₄)₃@reduced graphene oxide (NVP@rGO) particles on a carbon-fiber-paper substrate (see Method). NVP is a positive electrode material for rapid and reversible Na ion insertion/de-insertion in its lattice, and the interconnected conducting network formed by rGO sheets further enhanced the charge transfer process. Powder X-ray diffraction (XRD) measurements showed a NASICON-type framework with R3̅c̅ space group with high crystallinity of the synthesized NVP@rGO particles (FIG. 11). SEM and transmission electron microscopy (TEM) showed NVP particles several hundred micrometers in size blended with rGO sheets (FIGS. 12 and 13). The lattice fringes with d-spacings of about 0.44 nm and about 0.34 nm were assigned to the (104) planes of rhombohedral NVP and (002) planes of multi-layered rGO respectively. The rGO content of the NVP@rGO hybrid was about 1.1 wt. % determined by thermogravimetric analysis (TGA, FIG. 14).

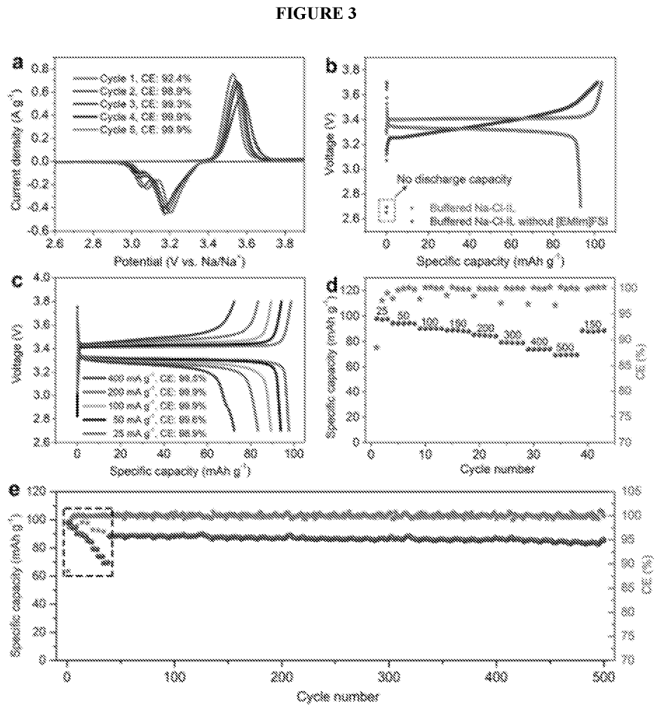

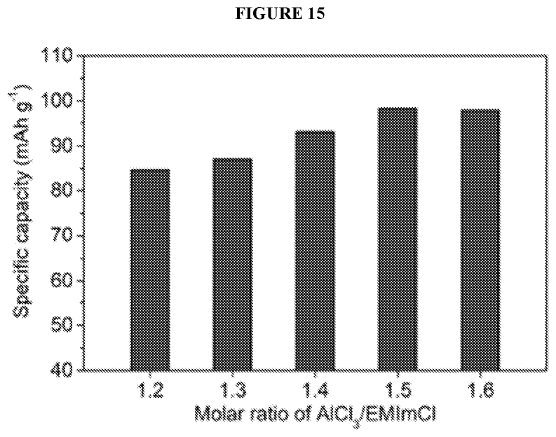

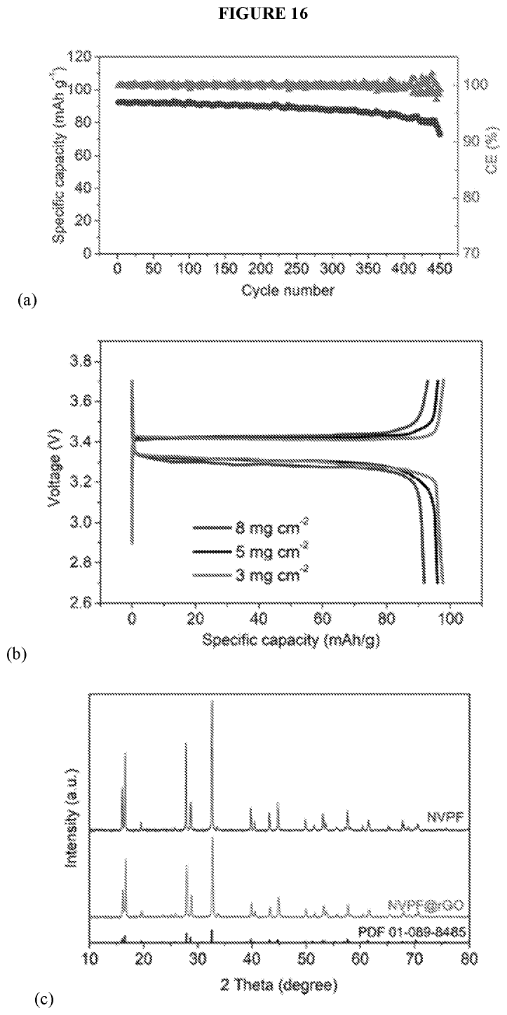

Cyclic voltammetry of a Na/NVP@rGO cell with the optimized buffered Na—Cl-IL electrolyte (see FIG. 15 for electrolyte optimization) showed a pair of oxidation and reduction peaks corresponding to the redox reactions of V³⁺/V⁴⁺ couples, and the CE increased to about 99.9% within four cycles and then stabilized (FIG. 3a). A mass loading of NVP@rGO of about 3.0 mg cm⁻² was used unless specified otherwise. A charge-discharge plateau at about 3.4 V was seen with a specific discharge capacity of about 93.3 mA g⁻¹ based on the mass of NVP@rGO at a rate of about 25 mA g⁻¹ (FIG. 3b). In striking contrast, the buffered Na—Cl-IL electrolyte without [EMIm]FSI additive showed a negligible discharge capacity (about 0.03 mAh g⁻¹) (FIG. 3b). The Na/NVP@rGO cell in buffered Na—Cl-IL electrolyte showed good rate capabilities at higher rates (FIG. 3c), with a specific discharge capacity of about 70 mAh g⁻¹ at about 500 mA g⁻¹ (about 4.3 C), which was about 71% of the specific capacity at about 25 mA g⁻¹ (FIG. 3d). The Na/NVP@rGO cell could retain about 96% of the initial capacity for over 460 cycles at about 150 mA g⁻¹ (about 0.4 mA cm⁻²) with a high average CE of about 99.9% (FIG. 3e). This was the first time > about 99% CE was achieved for Na metal battery in buffered chloroaluminate IL electrolytes. In comparison, a Na/NVP@rGO cell based on an organic carbonate electrolyte, about 1 M NaClO₄ in ethylene carbonate/diethyl carbonate (EC/DEC, 1:1 by vol.) with 5 about wt. % fluoroethylene carbonate (FEC) retained about 79% of the initial capacity after 450 cycles at about 150 mA g⁻¹ (FIG. 16a), which is significantly lower than about 96% based on buffered Na—Cl-IL electrolyte under the same condition. A similarly high average CE of about 99.9% was demonstrated in organic electrolyte when the cell was stably cycled, but CE fluctuation was observed after 400 cycles (FIG. 16a). The Na/NVP@rGO cell based on buffered Na—Cl-IL electrolyte realized an approximate 100-cycle longer cycle life compared with that using organic electrolyte. With an increased NVP@rGO mass loading of about 8.0 mg cm⁻², a specific discharge capacity of about 92 mAh g⁻¹ was delivered at about 25 mA g⁻¹ using buffered Na—Cl-IL electrolyte, corresponding to about 94% of the capacity with about 3.0 mg cm⁻² loading (FIG. 16b). A slightly lower CE of about 99.0% was demonstrated at the loading of about 8.0 mg cm⁻² compared with about 99.9% at about 3.0 mg cm⁻².

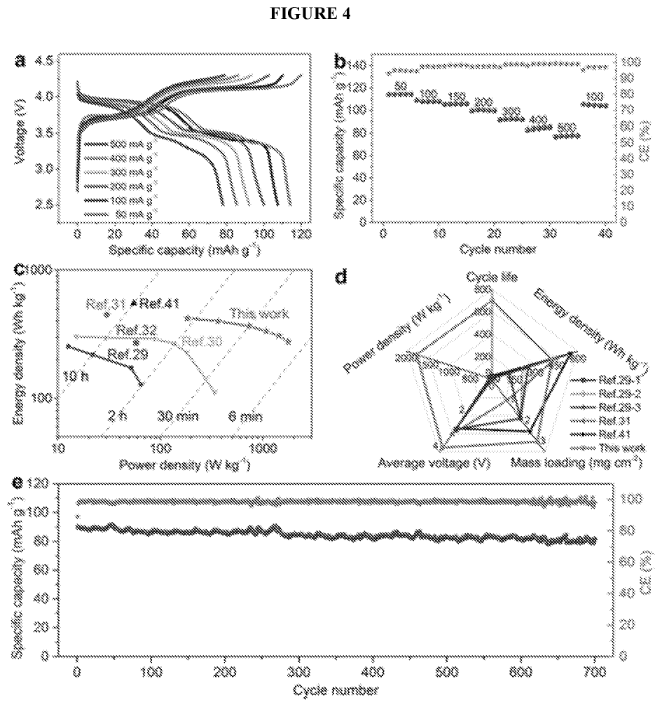

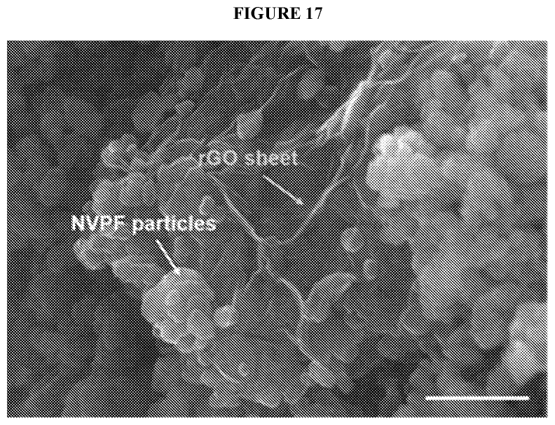

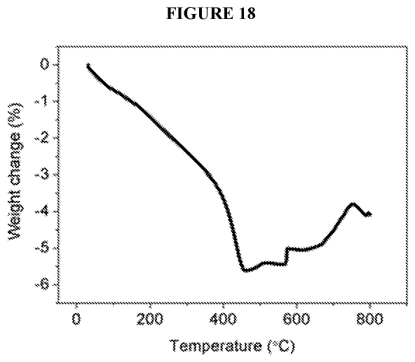

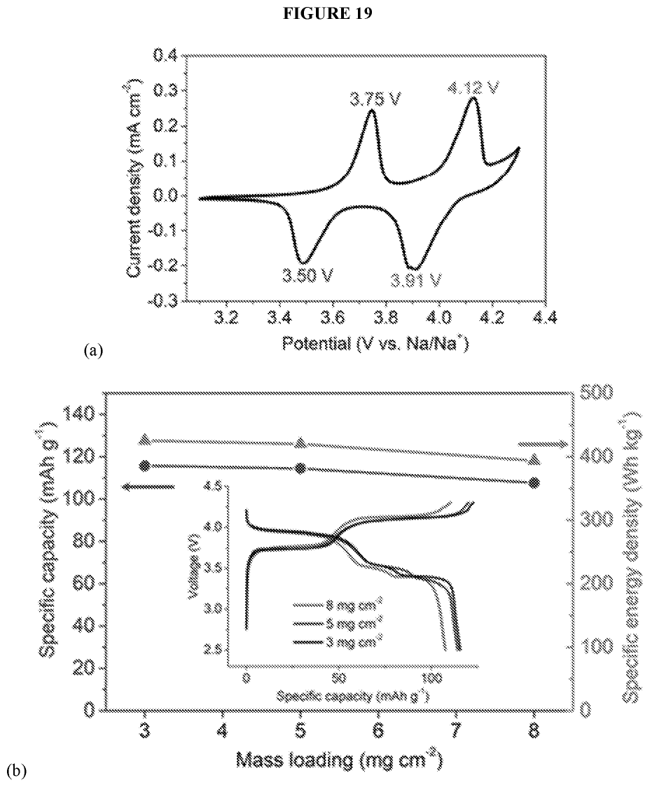

With a stable voltage window up to about 4.6 V (FIG. 2a), the buffered Na—Cl-IL electrolyte was compatible with higher voltage positive electrodes such as Na₃V₂(PO₄)₂F₃@rGO to afford Na metal battery cells with higher discharge voltage and energy density. Synthesis was made of NVPF@rGO by a hydrothermal method, in which NVPF@rGO hybrid was prepared via a one-step and low-temperature (about 120° C.) method without any freeze drying or annealing treatments (see Method). XRD patterns (FIG. 16c) indicated the prepared NVPF and NVPF@rGO mainly comprised of tetragonal Na₃V₂(PO₄)₂F₃ (ICDD PDF No. 01-089-8485) with an average size of about 100 nm. The NVPF particles were uniformly hybridized with rGO sheets, affording an interconnected conducting network to enhance electron transfer (FIG. 17). The rGO content of the NVPF@rGO hybrid was about 4.4% verified by TGA (FIG. 18). Two pairs of oxidation and reduction peaks (about 3.75 V/3.5 V and about 4.12 V/3.91 V) were observed in the CV curves of the positive electrode, corresponding to redox reactions of V³⁺/V⁴⁺ and couples respectively (FIG. 19a). Compared to NVP@rGO with V³⁺/V⁴⁺ redox, the introduction of fluorine in NVPF@rGO allowed stable V⁴⁺/V⁵⁺ redox, affording a higher charge/discharge plateau at about 4 V. The Na/NVPF@rGO cell based on buffered Na—Cl-IL electrolyte demonstrated good rate performances under about 50 to about 500 mA g⁻¹ (about 0.16 to about 1.6 mA cm⁻²) current densities and CEs from about 95% to about 99% (FIGS. 4a and 4b). The maximal energy density was about 420 Wh kg⁻¹ based on the mass of NVPF@rGO. With an increase of NVPF mass loading from about 3.0 to about 8.0 mg cm⁻², both the specific capacity and energy density were well retained, with an energy density of about 394 Wh kg⁻¹ at a mass loading of NVPF@rGO of about 8.0 mg cm⁻² operated under about 50 mA g⁻¹ (about 0.4 mA cm⁻²) current (FIG. 19b). The NVPF@rGO positive electrode showed high energy density at various rates in the buffered Na—Cl-IL electrolyte (FIG. 4c), delivering an energy density of about 276 Wh kg⁻¹ in about 10 min discharging time, corresponding to a power density of about 1766 W kg⁻¹ based on the mass of NVPF@rGO at a current density of about 500 mA g⁻¹ (about 1.6 mA cm⁻²). The superior rate performance over other NVPF-based positive electrodes in IL electrolytes was attributed to the about 2-20 fold higher ionic conductivity of the Na—Cl-IL electrolyte, and the NVPF@rGO hybrid that facilitated charge transfer.

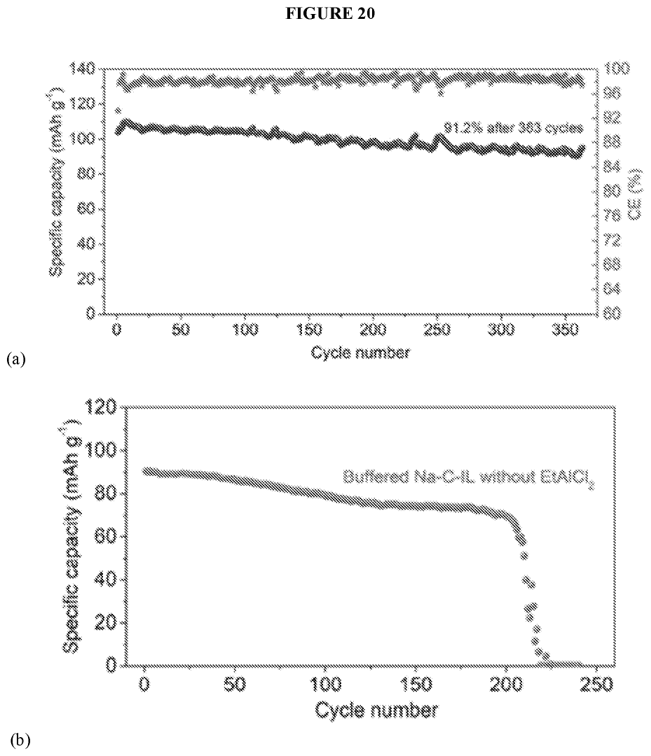

The Na/NVPF@rGO cell with a NVPF@rGO mass loading of about 3.0 mg cm⁻² showed excellent cycling stability in the IL electrolyte, retaining more than about 90% of the initial specific capacity over 710 cycles at a current density of about 300 mA g⁻¹ (about 0.81 mA cm⁻²) with an average CE of about 98.5% (FIG. 4e). At a higher NVPF@rGO mass loading of about 5.3 mg cm⁻², a Na/NVPF@rGO cell could retain about 91% of the initial specific capacity after 360 galvanostatic charge-discharge cycles at about 150 mA g⁻¹ (about 0.7 mA cm⁻²) with an average CE of about 98.2% (FIG. 20a). The key performance parameters of the Na/NVPF@rGO cell in buffered Na—Cl-IL electrolyte including energy/power density, cycle life, discharge voltage and mass loading outperformed other cells based on room-temperature IL electrolytes (FIG. 4d and Table 1).

The EtAlCl₂ additive was found important to enhance the cycling stability of Na batteries with Na—Cl-IL electrolyte, when comparing two Na/NVPF@rGO cells in IL electrolytes with and without about 1 wt. % EtAlCl₂ (FIG. 20b). The presence of EtAlCl₂ additive improved cycle life by about 500 cycles at about 300 mA g⁻¹, which could be explained by the elimination of trace amounts of residual protons and free chloride ions in the electrolyte via equation (4).

### Solid-Electrolyte Interphase Chemistry of Na—Cl-IL Electrolyte

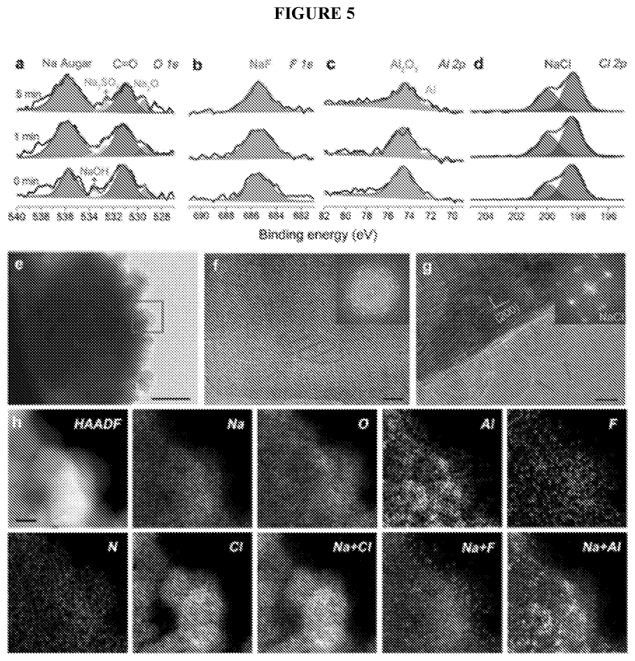

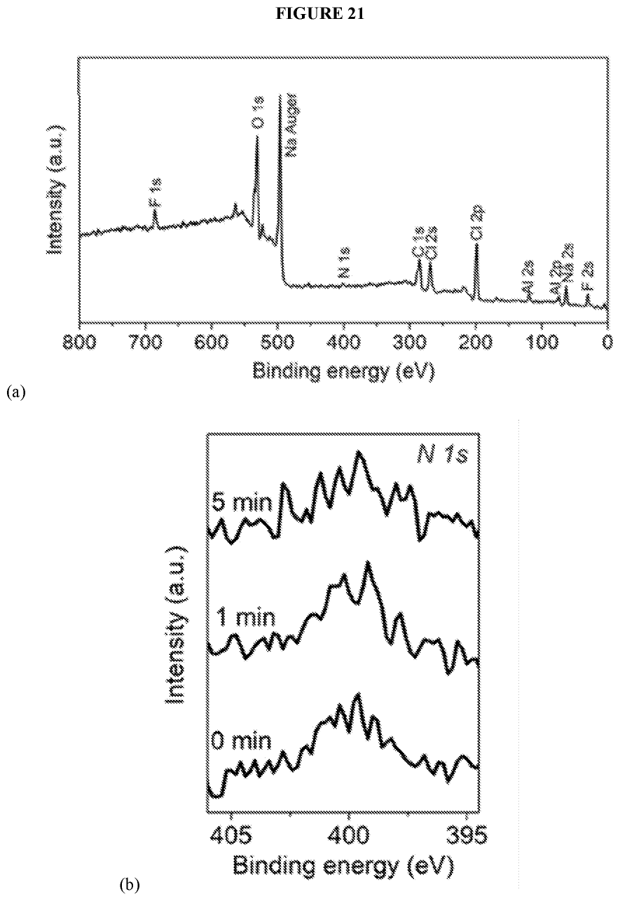

SEI plays a role in stabilizing the interface between alkali metal negative electrodes and electrolytes. Due to the unusual composition of the IL electrolyte, the SEI chemistry could be different from that in organic electrolytes. To this end analysis is made of the elemental composition and depth profile by X-ray photoelectron spectroscopy (XPS) of a Na negative electrode from a Na/NVP@rGO cell with the mass loading of NVP@rGO of about 5.0 mg cm⁻². The cell was cycled for 20 cycles at about 100 mA g⁻¹ (about 0.5 mA cm⁻²) and stopped at a fully charged state (Na plated on negative electrode). Surface XPS profile identified the presence of Na, O, C, Cl, F, Al and N (FIG. 21a). XPS profiling by Ar sputtering showed pronounced Na Auger peak at about 535.7 eV at all sample depths (FIG. 5a). The 0 is peaks at about 531.2, about 529.4, about 532.2 and about 533.6 eV indicated the presence of Na₂CO₃, Na₂O, Na₂SO₄ and NaOH, respectively (FIG. 5a). The presence of NaOH was solely at the surface, as it was generated from the contamination by water when the sample was briefly exposed to air during transfer to XPS. Part of the Na₂CO₃ could also be from reaction with water and carbon dioxide in air and decreased in intensity after sputtering. In contrast, the intensity of Na₂O and Na₂SO₄, formed by FSI anion and sodium metal showed no noticeable decrease during sputtering, indicating their existence in SEI. As expected, the F is peak at about 685.5 eV confirmed the presence of NaF as the major F-based SEI (FIG. 5b). The FSI anions in [EMIm]FSI were responsible for F-based SEI via reactions with the highly reactive Na metal. The Al 2p peaks at about 74.5 eV indicated the presence of Al₂O₃ as a major Al-based SEI component with a small portion of metallic Al observed (FIG. 5c). The two pronounced peaks at about 198.4 and about 199.8 eV corresponded to Cl 2p_{1/2} and Cl 2p_{3/2} peaks, indicating NaCl as another major SEI component (FIG. 5d). The weak N is peak at about 400 eV indicated the presence of N-based species generated from the decomposition of FSI anion (FIG. 21b), consistent with LiFSI-based organic electrolytes. Overall, a hybrid SEI formed on sodium metal comprised of NaF, Na₂O, Na₂SO₄, Al₂O₃, Al and NaCl contributed to the reversible plating/stripping process of Na in buffered Na—Cl-IL electrolyte.

To gain a deeper insight into the Na plating process in buffered Na—Cl-IL electrolyte, cryogenic transmission electron microscope (Cryo-TEM) was used to probe the morphology and elemental composition of plated Na on Cu grids without exposing the sample to air (see Method). Cryo-TEM is a powerful tool in probing the morphological and component information of beam-sensitive battery materials such as Li metal, but not yet used for investigating SEI on sodium thus far. Investigation is made of the initial Na plating on a Cu grid, which involved Na growth and SEI formation at the initial stage. The plated Na (without exposing to air) demonstrated a spherical morphology (FIG. 5e). High-resolution image showed some clusters in SEI with clear lattice fringes showing a d-spacing of about 0.347 nm indexed to the (012) planes of α-Al₂O₃, which was also confirmed by diffraction pattern (FIG. 5f). In addition, the compact stacking of many nanocubes with an average size of about 10 nm was observed on the edge of SEI, with lattice fringes at a d-spacing of about 0.284 nm indexed to (200) planes of NaCl and corroborated by diffraction pattern (FIG. 5g).

Element mapping analysis on these regions was performed using scanning transmission electron microscopy (STEM), indicating the presence of Na, O, Cl, Al, F and N that was in accordance with the XPS results, confirming the hybrid SEI composition of this IL electrolyte (FIG. 5h). The overlapped Na and Cl mapping indicated the presence of NaCl, consistent with the stacking cubes and diffraction pattern of NaCl detected in Cryo-TEM (FIG. 5f). The F mapping mainly distributed in the region near the surface, and showed a good overlap with Na mapping, which was in accordance with the XPS results that indicated the presence of NaF layer. The merged Na and Al mapping showed the aggregation of Al with the formation of some Al clusters, rather than distributed uniformly with Na in the SEI matrix (FIG. 5h). It can be explained by the fact that Al and Na cannot form alloy, thus Al might prefer to plate on Al rather than Na, which could account for the interconnected structure of Al observed in the mapping image.

### Discussion

Compared with other IL electrolytes for Na cells, the Na—Cl-IL electrolyte system is interesting in several ways. First, the high ionic conductivity (about 9.2 mS cm⁻¹ at about 25° C.) outperforms other IL electrolytes based on bulky cations (e.g., benzyldimethylethylammonium and N-butyl-N-methylpyrrolidinium) and anions (e.g., FSP and TFSI⁻), allowing for both high energy density and rate capability/power density of the Na metal cells (see Table 1). The EMIm cation is of note among other cations since it provides delocalized positive charge around the imidazolium ring, effectively increasing the cation-anion distance and affording lower viscosities than ILs with other cations, owing to reduced Coulomb (electrostatic) interactions between ion pairs. Second, the SEI components are of note with the inclusion of Ala, and NaCl due to Na reaction/passivation by chloroaluminate species, which facilitates the stabilization of Na plating/stripping cycling. This led to a cycle life of over 700 cycles, the longest among reported IL-based Na cells (FIG. 4d).

TABLE 1

[symbol]

[symbol]

indicates data missing or illegible when filed

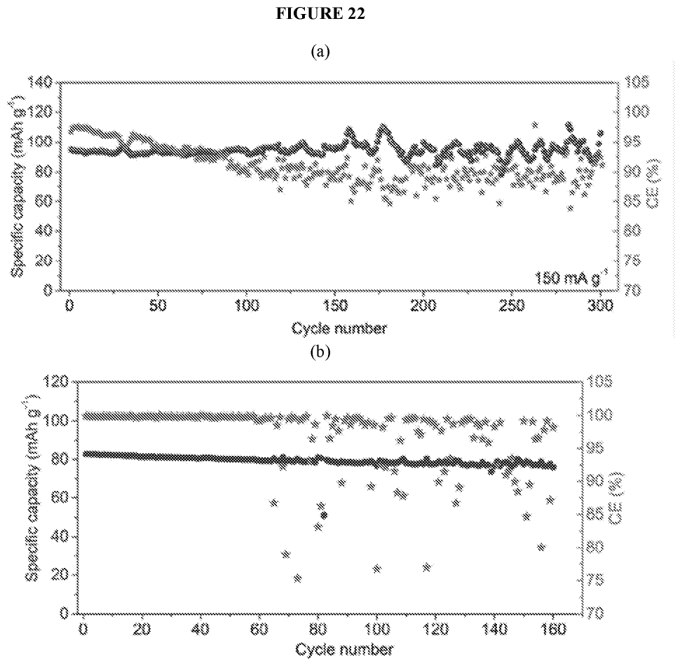

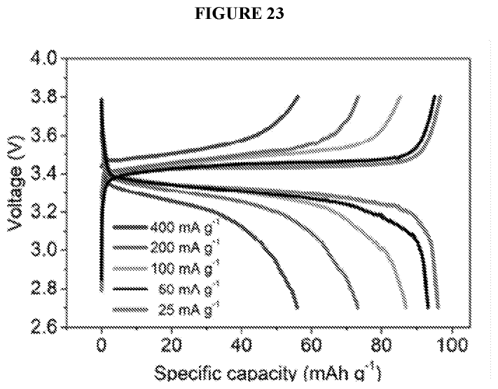

Although FSI anions was important for a stable SEI in the system, FSI alone was not sufficient for long cycle life of Na negative electrode. This was based on inferior cycling stability of Na/NVP@rGO cell in a non-chloroaluminate based electrolyte 1 M NaFSI in [EMIm]FSI IL electrolyte, displaying low and fluctuating CEs of about 90%, despite the fact that it had a much higher FSI anion concentration of about 6 M compared with about 0.2 M in the buffered Na—Cl-IL electrolyte (FIG. 21). Similarly, the Na/NVP@rGO cell using NaFSI in N-propyl-N-methylpyrrolidinium bis(fluorosufonyl)imide IL electrolyte (molar ratio of about 2:8) showed fluctuating CEs after about 65 cycles when cycling at about 150 mA g⁻¹ (FIG. 22). In addition, an inferior rate performance was demonstrated using NaFSI/N-propyl-N-methylpyrrolidinium bis(fluorosufonyl)imide IL electrolyte compared with that based on buffered Na—Cl-IL electrolyte (FIG. 23).

Another important aspect was that other IL electrolytes with highly concentrated F-based species (e.g., over about 5 M of FSI anion concentration in NaFSI-[N-propyl-N-methylpyrrolidinium]FSI electrolyte with a molar ratio of about 2:8) were much higher in cost than organic electrolytes due to expensive FSI species. A much lower FSI concentration of about 0.2 M was included for the buffered Na—Cl-IL electrolyte, and at the same time reaching better cell performances (power density, CE, cycle life and discharge voltage etc.) than other room temperature IL electrolytes (Table 1). The buffered Na—Cl-IL electrolyte could be a promising candidate for affordable, high-safety energy storage towards real-world applications.

In conclusion, development is made of a non-flammable and highly conductive ionic liquid electrolyte for high-energy/high-voltage Na metal batteries. The ionic liquid electrolyte is comprised of AlCl₃, NaCl and [EMIm]Cl and allows reversible Na plating/stripping upon addition of two additives, namely ethylaluminum dichloride and 1-ethyl-3-methylimidazolium bis(fluorosulfonyl)imide. The Na metal cells with NVP and NVPF positive electrodes achieve high CE up to about 99.9%, and high energy and power density of about 420 Wh kg and about 1766 W kg, respectively. Over about 90% of the original capacity can be retained after over 700 galvanostatic charge-discharge cycles. The solid-electrolyte interphase (SEI) probed by XPS and Cryo-TEM shows that the major components included NaCl, Al₂O₃ and NaF. The non-flammable and highly conductive IL electrolyte can serve as a promising candidate for sodium batteries with high safety and high performance, and can be potentially extended to a broad range of rechargeable battery systems such as Li and K batteries.

### Methods

Preparation of IL electrolytes. IL electrolytes were prepared in an Ar-filled glove box with water and oxygen content below 2 ppm. [EMIm]AlₓCl_{y} IL was first made by mixing 1-ethyl-3-methylimidazolium chloride ([EMIm]Cl) and anhydrous AlCl₃ (≥99.0%, Fluka). [EMIm]Cl was dried at about 80° C. under vacuum for about 24 h to remove residual water. For a certain molar ratio, e.g., about 1.5 of AlCl₃/[EMIm]Cl, about 1.78 g of [EMIm]Cl and about 2.4 g of AlCl₃ were weighed in two glass vials, respectively. A small portion of AlCl₃ was then slowly added into [EMIm]Cl to avoid dramatic heat generation during the mixing. This process was repeated until all the AlCl₃ were introduced, and the mixture was stirred until all the solid was dissolved, followed by adding about 0.3 g of aluminum foil for purification. About 1.8 g of the obtained light-yellow, clear liquid was kept at about 70° C. for about 1 h under vacuum for removal of water, followed by adding about 0.172 g NaCl (99.999%, Sigma-Aldrich) and allowed to stir for about 24 h. The supernatant was collected, and stirred with about 1 wt. % EtAlCl₂ (Sigma-Aldrich) for about 1 h. The mixture was further added with about 4 wt. % [EMIm]FSI (dried at about 70° C. under vacuum for about 12 h before use) and allowed to stir for about 6 h to obtain the buffered+EtAlCl₂/[EMIm]FSI additive electrolyte. To avoid water absorption of the prepared IL electrolyte, all the agents were stored inside tightly closed and sealed bottles, and placed in Ar-filled glove box. [EMIm]Cl and NaCl were dried via heating under vacuum before use. [EMIm]FSI and N-propyl-N-methylpyrrolidinium bis(fluorosufonyl)imide were dried under vacuum at about 70° C. for about 12 h before dissolving NaFSI salt. About 1 M NaClO₄ in EC/DEC (1:1 by vol) with about 5 wt. % FEC was prepared as organic electrolyte for comparison.

Preparation of NVP@rGO and NVPF@rGO. Graphene oxide (GO) was synthesized via a modified Hummer's method with more details described in herein. To prepare NVP@rGO, about 0.69 g of NH₄H₂PO₄, about 0.318 g of Na₂CO₃ and about 0.364 g of V₂O₅ were dispersed in deionized water, followed by adding about 0.72 g of oxalic acid (≥99.0%, Sigma-Aldrich) at about 70° C. The mixture was added with about 7.3 mL GO aqueous dispersion (about 11 mg mL⁻¹) under vigorous stirring, and then freeze-dried to obtain the solid NVP@GO precursor. The precursor was grounded using an agate mortar, followed by sintering at about 850° C. with a heating rate of about 2° C. min⁻¹ in Ar to obtain the NVP@rGO powder. NVPF@rGO was prepared via a one-step hydrothermal method. Briefly, about 0.536 g of NaF, about 3.51 g of NaH₂PO₄ and about 1.763 g of VOSO₄.xH₂O (degree of hydration 3-5, Sigma-Aldrich) were dissolved in about 30 mL deionized water, followed by mixing with about 7.8 mL of GO aqueous dispersion (about 11 mg mL⁻¹) for about 1 h to obtain a uniform dispersion. The mixture was immediately transferred into a 45 mL Teflon-lined stainless steel autoclave and kept at about 120° C. for about 10 h. The resulted precipitates were centrifuged at about 4,000 rpm using deionized water for 5 times, and the obtained solid was dried at about 80° C. for about 10 h in a vacuum oven to obtain the NVPF@rGO powder. For bare NVPF, no GO was added with all the other procedures remained the same.

Electrochemical measurements. All the electrochemical measurements were conducted at room temperature (about 22° C.) unless otherwise specified. To prepare slurries, about 70 wt. % NVP@rGO or NVPF@rGO powder was mixed with about 20 wt. % conductive carbon black (Super C65, TIMICAL) and about 10 wt. % polyvinylidene fluoride (PVDF, Mw=180,000, Sigma-Aldrich) in N-methyl-2-pyrrolidone (NMP, 99.5%, Sigma-Aldrich). The mixture was stirred for about 10 h until a uniform and viscose slurry was obtained, which was coated on a Mitsubishi carbon fibre paper (M30 type, 30 g m⁻²). The electrodes were baked in about 120° C. vacuum oven for about 2 h for removal of the residual NMP. The electrochemical performances were measured in pouch-type cells. Briefly, carbon tap (Ted Pella) was used to paste the positive electrode (Cu or Pt foil, NVP@rGO or NVPF@rGO electrodes) and negative electrode of Na metal foil onto an aluminum laminated pouch. The Na foil was prepared by rinsing a Na cube (99.9%, Sigma-Aldrich) in anhydrous dimethyl carbonate (≥99.0%, Sigma-Aldrich) for removal of the mineral oil on surface, cutting off the surface oxidation with blades, and pressing a fresh piece into a thin foil. Two nickel tabs (EQ-PLiB-NTA3, MTI) and a piece of glass fiber filter paper (GF/A, Whanman) were served as the current collector and separator, respectively. The obtained pouch was heated in about 80° C. vacuum oven for about 8 h, and then transferred into an argon-filled glove box with water and oxygen content below 2 ppm to fill in the electrolyte (200 μL for each cell). The pouch was heat-sealed in the glove box before transferring out for further electrochemical measurement. Cyclic voltammetry was performed on a CHI760E electrochemical work station. The charge-discharge performances of the cells were measured with a Neware battery testing system (CT-4008-5V50 mA-164-U). All the cells were allowed to age for about 6 h before charge-discharge measurement. The specific capacity, energy and power density were calculated based on the total mass of NVP@rGO and NVPF@rGO.

Characterization. For Raman spectra, IL electrolytes were injected and sealed into transparent plastic pouches in an Ar-filled glove box. The spectra were acquired (250-500 cm⁻¹) using an Ar⁺ laser (532 nm) with 0.8 cm⁻¹ resolution. The conductivity measurement was performed on a conductivity meter (FiveEasy Plus, Mettler Toledo). Prior to characterization, the electrodes were rinsed with anhydrous dimethyl carbonate for 6 times, and dried under vacuum at room temperature. They were further sealed in Ar-filled pouches and quickly transferred into the vacuum chamber to avoid too much exposure to air. The Na ion concentration of the buffered Na—Cl-IL electrolyte was measured using a Thermo Scientific ICAP 6300 Duo View Spectrometer. SEM images were acquired from a Hitachi/S-4800 SEM operated at 15 kV, and EDS analysis was performed on a Horiba/Ex-450 EDS spectroscopy. FIB-SEM was performed on a dual-beam field-emitting focused ion beam microscope (VERSA 3D DualBeam) with an accelerating voltage of 20 kV. TEM image of NVP@rGO was obtained with a JEOL JEM-2100F operated at 200 kV. XRD pattern was measured with a Bruker D8 Advance powder X-ray diffractometer with Cu Kα radiation. TGA measurement was performed on a PerkinElmer/Diamond TG/DTA thermal analyser at a heating rate of about 5° C. min⁻¹ in air for NVP@rGO and NVPF@rGO, and in nitrogen for IL and organic electrolyte, respectively. The temperature range used for determining rGO percentage was about 180-460° C., and the weight loss below about 180° C. was due to water removal that is also used to determine the water content of products synthesized in aqueous solution. XPS spectra were collected on a PHI 5000 VersaProbe Scanning XPS Microprobe. All the binding energy values were calibrated with C1s peak (284.6 eV). Depth profile was conducted using Ar ion sputtering at 1 kV and 0.5 μA over a 2×2 mm area, corresponding to a SiO₂ sputter rate of about 2 nm min⁻¹. Glass fiber separators soaked with electrolyte were used to test the flammability of the electrolyte. Cryo-TEM was performed on an FEI Titan Krios cryogenic transmission electron microscope operated at 300 kV. Na was plated on a Cu TEM grid in a 2032 type coin cell at a current density of about 0.2 mA cm⁻² for about 30 min, using about 150 μL Na—Cl-IL and one glass fiber as electrolyte and separator, respectively. The coin cell was disassembled in an Ar-filled glove box, followed by removing the residual electrolyte on Na-plated Cu TEM grid using anhydrous DMC and drying it under vacuum. The TEM grid was then carefully mounted onto a TEM cryo-holder and transferred into the chamber of Cryo-TEM without exposing to air. Similar processes were performed for element mapping using a FEI Titan Themis 60-300 transmission electron microscope equipped with a cooling sample holder.

### NaFSI and NaTFSI as Additives for Sodium-Carbon Batteries

Preparation of microporous carbon nanosphere. About 1.5 g of triblock copolymer F-127 (PEO106-PPO70-PEO106) was added and stirred in a mixture of about 300 ml of deionized water and about 120 ml of ethanol (95%) at room temperature for about 10 minutes. About 3 g of aqueous ammonia solution (25%) was then added in the F127 solution and stirred for about 30 minutes followed by adding about 3 g of resorcinol as a carbon source into the solution. Finally, about 4.578 g of aqueous formaldehyde solution (formaldehyde solution, about 37 wt. %) was gradually dropped into the solution and stirred for about 24 hours at room temperature. The solid suspension was formed. The centrifugation was conducted to separate the solid and liquid with a rotation speed of about 14900 rpm. Solid was collected and dried at about 100° C. The material was heated at about 350° C. for about 2 hours in a nitrogen atmosphere with a heating rate of about 1° C./min to remove the template of F127. For the carbonization process, the material was heated at about 800° C. for about 4 hours in a nitrogen atmosphere with a heating rate of about 1° C./min. The carbonized nanospheres were obtained. The activation process of the nanospheres was carried out in a tubular furnace at about 1000° C. (a heating rate of about 5° C./min) with admitting CO₂ for about 75 minutes. The microporous carbon nanospheres were obtained.

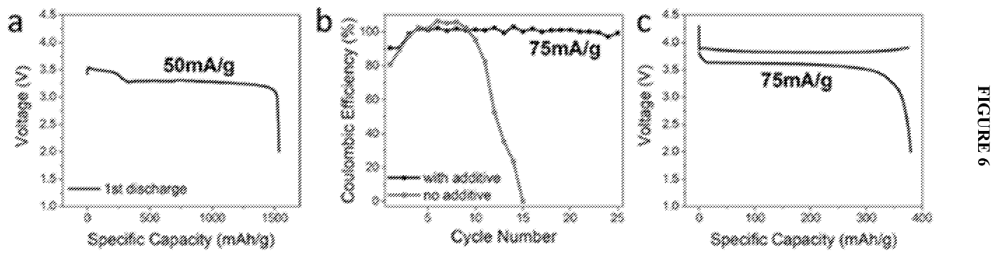

A mixture of sodium bis(fluorosulfonyl)imide (NaFSI) and sodium bis(trifluoromethanesulfonyl)imide (NaTFSI) could be used as additives to stabilize a battery using sodium as the negative electrode and microporous carbon nanosphere as the positive electrode. The electrolyte was formed by dissolving about 3 M aluminum chloride (AlCl₃) in thionyl chloride (SOCl₂) with the addition of about 2 wt. % NaFSI (about 0.218 M) and about 2 wt. % NaTFSI (about 0.147 M). The first discharge of the battery could deliver about 1535 mAh/g specific capacity with a discharge voltage at about 3.3V (FIG. 6a). The additives were important in helping the battery achieve a stable cycling performance. Cycling at a charging specific capacity of about 375 mAh/g and with the additive present, the battery could maintain a very stable Coulombic Efficiency at about 100% for at least 25 cycles. In contrast, without the additives, the battery could cycle stably for less than 10 cycles and then the Coulombic Efficiency dropped significantly. The battery completely died at around cycle 15 (FIG. 6b). The battery showed very small overpotential (about 0.2V) in charge discharge and delivered an energy density of about 1335 mWh/g with an energy efficiency of about 92.8% (FIG. 6c). In addition to the microporous carbon nanosphere described above, other carbon-based materials, including nanographite and micrographite (Nano19 and Micro850 from Asbury carbons), could be used as the positive electrode as well. The electrolyte composition could also be changed, as long as the additives described above were present. For example, sodium chloride (NaCl) could also be added to partially buffer the electrolyte acidity.

### Additional Methods

Preparation of graphene oxide. About 1 g flake graphite powder was pre-oxidized in the mixture of about 30 mL sulfuric acid and about 10 mL nitric acid under stirring for about 24 h. After washing with deionized water and drying, the obtained powder was exfoliated in a tube furnace at about 1000° C. for about 10 s, followed by reacting with about 60 mL oleum, about 0.84 g K₂S₂O₈ and about 1.3 g P₂O₅ at about 80° C. for about 5 h under stirring. After cooling down to room temperature, about 500 mL deionized water was slowly added to the suspension, and the dried products were obtained by vacuum filtrating and washing for 3 times, and dried in a vacuum oven. The resulted powder was added to about 50 mL oleum in ice bath, followed by adding about 3 g KMnO₄ slowly under vigorous stirring, during which the temperature was kept below about 20° C. The mixture was then heated to about 35° C. and stirred for another about 2 h, and diluted with about 500 mL deionized water and added with about 2 mL of about 30 wt. % H₂O₂. The dispersion was left overnight, and the brown gel at bottom was washed with deionized water, followed by centrifuging with about 1 M HCl solution for 5 times, and then washing with deionized water until the decantate turned nearly neutral.

Details of battery assembly and testing. The powders of NVP@rGO and NVPF@rGO are best to store in an Ar-filled glove box to avoid possible contaminations and absorption of moisture in air. Freshly prepared NVP@rGO and NVPF@rGO electrodes are desired for good battery performances. Sufficient contact between electrode and separator is important for good rate and cycling performances. The pouch cell was placed under vacuum for about 15 min after injecting the electrolyte to enhance the electrolyte permeation into separator and electrodes. The edges of the pouch cells were flattened, and the pouch was further clamped using two clips (0.75 inch, Clipco) between two hardboards for about 30 min, realizing a good contact between the electrode and separator. The clips were then removed and no extra pressure was applied on the battery during testing.

As used herein, the singular terms “a,” “an,” and “the” may include plural referents unless the context clearly dictates otherwise. Thus, for example, reference to an object may include multiple objects unless the context clearly dictates otherwise.

As used herein, the terms “connect,” “connected,” “connecting,” and “connection” refer to an operational coupling or linking. Connected objects can be directly coupled to one another or can be indirectly coupled to one another, such as through another set of objects.

As used herein, the terms “substantially,” “substantial,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “alkyl group” includes straight chain and branched alkyl groups having from 1 to about 20 carbon atoms, and typically from 1 to 12 carbons or, in some embodiments, from 1 to 8, 1 to 6, or 1 to 4 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as fluoro moieties.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claim(s). In addition, many modifications may be made to adapt a particular situation, material, composition of matter, method, operation or operations, to the objective, spirit and scope of the disclosure. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

1. A rechargeable alkali metal battery comprising:
an anode including an alkali metal;
a cathode; and
an electrolyte to support reversible plating and stripping of the alkali metal at the anode, wherein the electrolyte includes alkali metal ions, chloroaluminate anions (AlCl₄⁻), and an additive including imide anions.

2. The battery of claim 1, wherein the imide anions are selected from: 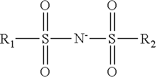
where R₁ and R₂ are the same or different, and are independently selected from (a) fluorine (F) and (b) linear or branched alkyl groups substituted with 1 or more fluorine atoms.

3. The battery of claim 1, the imide anions include bis(fluorosulfonyl)imide anions (FSI⁻), bis(trifluoromethanesulfonyl)imide anions (TFSI⁻), or both.

4. The battery of claim 1, wherein a molar concentration of the imide anions in the electrolyte is in a range of about 1 M or less, about 0.9 M or less, about 0.8 M or less, about 0.7 M or less, about 0.6 M or less, about 0.5 M or less, about 0.4 M or less, about 0.3 M or less, or about 0.2 M.

5. The battery of claim 1, wherein the electrolyte is an ionic liquid.

6. The battery of claim 5, wherein the ionic liquid further includes 1-ethyl-3-methylimidazolium (EMI) cations, imidazolium cations, pyrrolidinium cations, piperidinium cations, phosphonium cations, alkylammonium cations, or any combination thereof.

7. The battery of claim 1, wherein the electrolyte is an ionic liquid formed by adding alkali metal chloride to buffer an acidic AlCl₃/organic chloride ionic liquid to neutral, followed by adding an additive containing FSI⁻, TFSI⁻ or mixed FSI⁻/TFSI⁻ and a water removal agent.

8. The battery of claim 1, wherein the electrolyte is an ionic liquid formed by adding x part (0<x<1) of NaCl, 0.01-0.02 part of ethylaluminum chloride, 0.02 to 0.06 part of EMIFSI to 1 part of an acidic AlCl₃:1-ethyl-3-methylimidazolium chloride (EMIC) ionic liquid (AlCl₃:EMIC=1 to 1+x, 0<x<1).

9. The battery of claim 5, wherein the ionic liquid has an ionic conductivity at 25° C. of about 1 mS cm⁻¹ or greater, about 2 mS cm⁻¹ or greater, about 4 mS cm⁻¹ or greater, about 6 mS cm⁻¹ or greater, about 8 mS cm⁻¹ or greater, or about 9 mS cm⁻¹ or greater.

10. The battery of claim 1, wherein the electrolyte includes thionyl chloride dissolved with 0-5 M NaCl and 1-5 M AlCl₃, and 0-10 wt. % of an additive of NaFSI, NaTFSI, or mixed NaFSI and NaTFSI.

11. The battery of claim 1, wherein the electrolyte includes sulfuryl chloride dissolved with 0-5 M NaCl and 1-5 M AlCl₃, and 0-10 wt. % of an additive of NaFSI, NaTFSI, or mixed NaFSI and NaTFSI.

12. The battery of claim 1, wherein the electrolyte includes a solvate electrolyte formed by sulfur dioxide, NaCl and AlCl₃, and an additive of NaFSI, NaTFSI or mixed NaFSI and NaTFSI.

13. The battery of claim 1, wherein the electrolyte includes thionyl chloride dissolved with 0-5 M LiCl and 1-5 M AlCl₃, and 0-10 wt. % of an additive of LiFSI, LiTFSI, or mixed LiFSI and LiTFSI.

14. The battery of claim 1, wherein the electrolyte includes sulfuryl chloride dissolved with 0-5 M LiCl and 1-5 M AlCl₃, and 0-10 wt. % of an additive of LiFSI, LiTFSI, or mixed LiFSI and LiTFSI.

15. The battery of claim 1, wherein the electrolyte includes a solvate electrolyte formed by sulfur dioxide, LiCl and AlCl₃, and an additive of LiFSI, LiTFSI or mixed LiFSI and LiTFSI.

16. The battery of claim 1, wherein the cathode includes an inorganic material or an organic material.

17. The battery of claim 1, wherein the alkali metal is sodium.

18. The battery of claim 1, wherein the alkali metal is potassium.

19. The battery of claim 1, wherein the alkali metal is lithium.
